(19) United States
(12) Patent Application Publication
(10) Pub. No.: US 2026/0172475 A1
(43) Pub. Date: Jun. 18, 2026

(54) SYSTEMS AND METHODS TO IMPLEMENT REGULATORY AND BUSINESS RULES TO AIRCRAFT COMMUNICATION SYSTEMS

(71) Applicant: Panasonic Avionics Corporation, Irvine, CA (US)

(72) Inventors: Andrew THOMPSON, Rancho Mission Viejo, CA (US); Andrej RONCEVIC, Irvine, CA (US); Evandro PIOLI MORO, Santa Clarita, CA (US); Pawel PASTUSZAK, Irvine, CA (US)

(21) Appl. No.: 18/984,824

(22) Filed: Dec. 17, 2024

(51) Int. Cl. H04L 67/12; G06Q 50/40

(52) U.S. Cl. CPC H04L 67/12; G06Q 50/40

(57) ABSTRACT

A method comprises: detecting a triggering event related to operations of a feature implemented by a commercial transportation vehicle; receiving, in response to the detecting the triggering event, one or more requests associated with the feature, each of the one or more requests comprising a data structure containing information related to the operations of the feature associated with the request; querying at least one device or at least one database that supports the operations of the feature; aggregating one or more responses received from the at least one device or the at least one database in response to the querying; determining, based the aggregated one or more responses, a set of rules to configure the feature; and receiving the set of rules such that the feature operates based on the set of rules.

### TECHNICAL FIELD

This document is generally related to systems and methods to implement regulatory and business rules to communication systems of commercial transportation vehicles.

### BACKGROUND

Commercial transportation vehicles such as aircraft are commonly required to comply with regulations surrounding their operations. Such regulations may be subject to change at any time. Techniques that provide commercial transportation vehicles with up-to-date rules and regulations can ensure the safe and compliant operation of the vehicle and provide a positive travel experience for passengers onboard by minimizing disruption to in-vehicle services.

### SUMMARY

This patent document describes, among other things, various techniques for implementing regulatory and business rules for commercial transportation vehicle communication systems.

In one aspect, a computer-implemented method of operating a commercial transportation vehicle is provided. The method comprises: detecting a triggering event related to operations of a feature implemented by the commercial transportation vehicle; receiving, in response to the detecting the triggering event, one or more requests associated with the feature, each of the one or more requests comprising a data structure containing information related to the operations of the feature associated with the request; querying, based on the information contained in the data structure, at least one device or at least one database that supports the operations of the feature; aggregating one or more responses received from the at least one device or the at least one database in response to the querying; determining, based in part on the one or more responses, a set of rules to configure the feature; and receiving, by the commercial transportation vehicle, the set of rules such that the feature operates based on the set of rules. In some implementations, the feature comprises a service, a hardware or a software.

In another aspect, a system for operating a commercial transportation vehicle is provided. The system comprises: at least one storage configured to store data supporting a feature implemented by the commercial transportation vehicle; a server in communication with the at least one storage and the commercial transportation vehicle; and a computer-implemented device, wherein the computer-implemented device is configured to perform operations comprising: receive at least one data structure associated with the feature; query, based on information contained in the data structure, at least one of the server or the at least one storage; aggregate one or more responses received from the at least one of the server or the at least one storage in response to the querying; determine, based on the aggregated one or more responses, a set of rules to configure the feature; and communicate the set of rules to the feature such that the feature operates based on the set of rules. In some implementations, the feature comprises a service, a hardware or a software.

In another aspect, a computer readable medium is provided. The computer readable medium stores instructions, upon execution by a processor, causing the processor to implement a method as suggested in this patent document.

The above and other aspects and their implementations are described in greater detail in the drawings, the description, and the claims.

### BRIEF DESCRIPTION OF THE DRAWINGS

FIG. 1 shows an example of a communications system for a commercial transportation vehicle based on some implementations of the disclosed technology.

FIG. 2 shows an example of a configuration including a communications system based on some implementations of the disclosed technology.

FIG. 3 shows an example of a system in communication with a commercial transportation vehicle based on some implementations of the disclosed technology.

FIG. 4 shows an example of a block diagram of a system to provide various rules to a commercial transportation vehicle based on some implementations of the disclosed technology.

FIG. 5 shows a flow diagram of an example workflow of a communications system based on some implementations of the disclosed technology.

FIG. 6 shows an example of a method of providing rules to a commercial transportation vehicle based on some implementations of the disclosed technology.

### DETAILED DESCRIPTION

Commercial transportation vehicles such as aircraft, trains, buses, boats, and other similar vehicles use various computing devices to support in-vehicle functions including, among others, entertainment systems, wireless communications, system controls, and navigation. These computing devices generally include hardware (e.g., servers, switches, network interface cards, storage adapters, storage devices, etc.) and software (e.g., server applications, operating systems, firmware, management applications, application programing interfaces (APIs), etc.).

For many commercial transportation vehicles, in-vehicle functions are required to operate in accordance with certain rules and regulations which may be set by a governing body. For example, an aircraft may be required to utilize certain radio frequency channels for communications based on communication regulations set forth for the aircraft by the territory over which the aircraft is currently flying over. At the same time, various aircraft subsystems and services may be required to operate in accordance with a set of business rules typically set by the airlines e.g., a most cost-effective wireless communications network for passenger devices to connect to.

This patent document discloses various techniques to implement rules and regulations for commercial transportation vehicles. The technical solutions described in the present document can be embodied in implementations to improve passenger experiences, among other features, by providing improved techniques for providing commercial transportation vehicles with regulatory, business, and technical rules to configure in-vehicle systems, devices, and services. In some example embodiments, rules and regulations are stored in a centralized database that enables easier compliance of the commercial transportation vehicle to regulations. Some advantages of the disclosed technology include minimization of compliance risks, increased control over business rules and network decisions which can enable network optimization, and centralized databases and logic which can eliminate the need for per customer software customization.

Various implementations will be discussed in detail with reference to the figures below. In the description, an airplane is described as an example of a passenger commercial transportation vehicle, but the implementations of the disclosed technology can be applicable to other commercial transportation vehicles such as buses, trains, ships, freight liners, and other types of passenger or non-passenger vehicles, including autonomous or self-driving commercial vehicles.

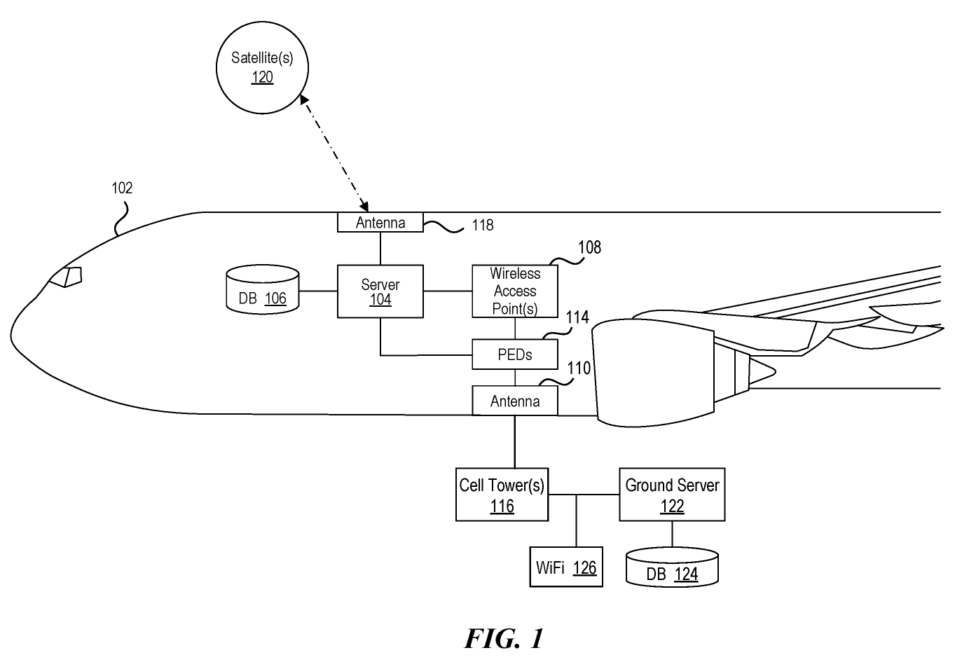

FIG. 1 shows an example of a communications system for a commercial transportation vehicle such as an airplane. The example diagram of the communications system as shown in FIG. 1 is provided to explain how wireless connections are supported in the airplane 102. The components shown as a single element in FIG. 1, e.g., the server 104, the database 106, the wireless access point(s) (WAPs) 108, etc. can be configured in multiple elements. For example, the communications system can include multiple servers, databases, and wireless access points to facilitate or support providing of wireless coverages for the airplane.

The communications system provides connectivity services to passengers on board and various in-vehicle systems. Referring to FIG. 1, the communications system includes a server 104, antenna 110, and antenna 118. Passengers often carry their own devices, which may include personal electronic devices (PEDs) 114 and other wireless electronic devices. PEDs may refer to any electronic computing device that includes one or more processors or circuitries for implementing the functions related to data storage, video and audio streaming, wired communications, wireless communications, etc. Examples of PEDs include cellular phones, smart phones, tablet computers, laptop computers, and other portable computing devices. In the implementations of the disclosed technology, the PEDs may have the capability to execute application software programs (“apps”) to perform various functions.

The server 104 is communicably coupled with the PEDs 114 and, in some implementations, media playback devices (unpictured) located onboard the aircraft. The communication between the server 104 and the onboard devices, including the media playback devices and the PEDs 114, is either realized by wired connections or wireless connections. For example, the communication among the server 104, the media playback devices, and the PEDs 114 are achieved, e.g., in the case of mounted seat entertainment terminals, by a provision of network plugs at the seat for plugging PEDs 114 to a wired onboard local area network. In some other implementations, the communications among the server 104, the media playback devices, and the PEDs 114 are achieved, e.g., via a GSM/3G/4G cellular network utilizing one or more onboard base station(s), Wi-Fi such as the wireless access point 108, and/or by Bluetooth. Thus, the server 104, the media playback devices, and the PEDs 114 form a local network aboard the airplane 102. In some implementations, the network is an Ethernet switch but can be based on other networking standards. The communications system can include an Ethernet switch unit which appropriately routes Ethernet frames carrying data and/or contents among the server 104 and PEDs 114 on the network. The Ethernet switch unit may allow various transmit-enabled devices on the aircraft (e.g., the server 104, the media playback devices, the PEDs 114, etc.) to communicate with one another. Examples of such devices may include Ethernet devices, devices that have short range transmission capability, tag devices (e.g., airtags), ebag, and so on. In some implementations, the communication among the server 104, in-vehicle systems, and onboard devices such as the PEDs 114 and media playback devices is achieved through the antenna 110 to and from the ground-based cell tower(s) 116 by, for example, a provision of network plugs at the seat for plugging PEDs to a wired onboard local area network. In some other implementations, the communication among the server 104, in-vehicle systems, and onboard devices such as the PEDs 114 and media playback devices is achieved through the antenna 118 to and from satellite(s) 120 in an orbit (e.g., via a cellular network utilizing one or more onboard base station(s), Wi-Fi utilizing the wireless access point 108, and/or Bluetooth).

In some implementations, the server 104 is further communicatively coupled with other systems, for example, a ground server 122 and the database 124 which are located outside the airplane 102, e.g., located in a computing center at an arbitrary location on the ground. The server 104 can communicate with the systems on ground such as the ground server 122 and the database 124 via the antenna 110 for receiving and transmitting information from/to the other systems. In some implementations, the server 104 can communicate with the systems on ground such as the ground server 122 and the database 124 via a wireless interface. For example, a satellite communication module and/or 3G/4G/5G transceiver module is mounted within the airplane 102 to which the server 104 is connected. The onboard server's connection to this communication module is realized via a wired line or, alternatively, via a wireless connection, e.g., by Wi-Fi. The communication module can also be attached to or integrated into the server 104. In the example of a satellite communication module, the communication module communicates via satellite(s) 120 (utilizing antenna 118 installed at the airplane 102) via one or more landline-based networks (WAN, Internet) to the ground server 122. In the example of a 3G/4G/5G transceiver module, the communication module communicates with a 3G/4G/5G mobile communication network on the ground which, in turn, connects the server 104 through potentially further landline-based networks (WAN, Internet) to the ground server 122. As further discussed later in this patent document, in the implementations of the disclosed technology, the server 104 operates to obtain various regulatory, business, and technical rules to configure in-vehicle systems, onboard devices, and in-vehicle services in accordance with the various regulatory, business, and technical rules which may be set forth by an external source (e.g., a territory associated with airspace over which the airplane is flying, a country of registration of the airplane, an airline, etc.).

In some examples, cell towers 116 communicate or interface with the antenna 110 of the airplane 102, such that ground systems such as the ground server 122 and the database 124, can transmit and receive data with the server 104 and other in-vehicle systems. In some implementations, Wi-Fi element 126 provides a wireless local area network (WLAN) to allow the server 104 to communicate with the ground systems. Thus, the cell towers 116 and the Wi-Fi element 126 may act as communication nodes between the antenna 110 of the airplane 102 and the ground systems such as the ground server 122 and the database 124. In some implementations, the server 122 implements a router for the wireless onboard networks and various functionalities disclosed herein to provide in-vehicle systems and devices onboard the airplane 102 with various rules for operating in accordance with predetermined standards. The ground server 122 may be in communication with the database 124 and provide information from the database 124 to the server 122 and store information received from the server 122 in the database 124. Although FIG. 1 shows that the database 124 is provided separately from the ground server 122, the database 124 can be provided as a part of the ground server 122.

The ground server 122 may provide the server 104 with basic and updated regulatory, business, and technical rules for the airplane 102 as will be further explained in detail later. In some implementations, the ground server 122 works as the source of the rule data or operates as an interface to other servers and networks hosting the rule data. For example, the server 104 can obtain from the ground server 122 information about regulatory, business, and technical rules for the airplane 102 and store the obtained information in the database 106. For example, when the airplane 102 is flying over or approaching a certain territory, the server 104 can obtain from the ground server 122 information regarding rules for operating systems and devices onboard the airplane 102 as set forth by the territory over which the airplane 102 is flying over or approaching.

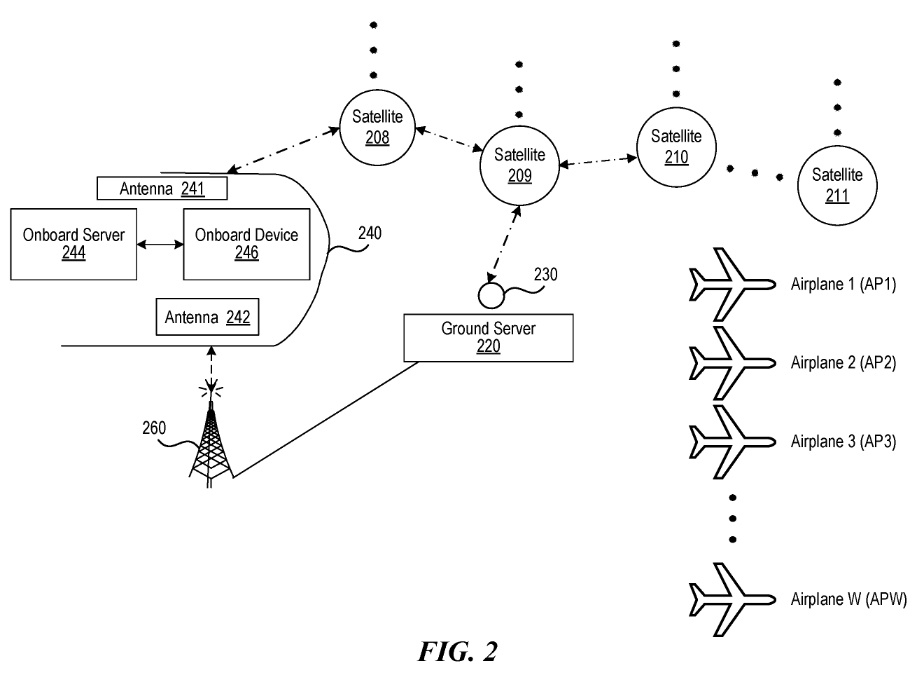

FIG. 2 shows an example of a configuration including a communications system based on some implementations of the disclosed technology. In the example system of FIG. 2, some elements of the aircraft 240 are shown, which include antennas 241 and 242, an onboard device 246 (e.g., a hardware device or PED), and an onboard server 244 in communication with the onboard device 246. The aircraft 240 is in communication with a ground server 220 through antennas 241 and 242 via one or more satellites 208, 209, 210, and 211 and/or a terrestrial communication station 260. The terrestrial communication station 260 is configured to provide cellular network for the aircraft 240. In the example, one or more satellites 208, 209, 210, and 211 are configured to provide satellite networks and include GEO (Geostationary Equatorial Orbit) satellites, MEO (Medium Earth Orbit) satellites, and/ LEO (Low Earth Orbit) satellites.

GEO satellites appear to be motionless in the sky, providing the satellite with a continuous view of a given area on the surface of the Earth. Such an orbit can only be obtained by placing the satellite directly above the Earth's equator (0° latitude), with a period equal to the Earth's rotational period. LEO satellites are placed in circular orbits at low altitudes of less than 2,000 km. A constellation of LEO satellites can provide continuous world-wide coverages, but this requires many satellites as each one is over a given region for a relatively small amount of time. Because of their relative lower distance to the Earth, latency, the delay caused by the distance a signal must travel, is far less than all other orbits. While the LEO satellite and the GEO satellite are described, those satellites are examples only and the satellite network can include other satellites without being limited to LEO satellite and the GEO satellite. The number of different types of satellites, which provides wireless connection services for the aircraft 240, can be varied as well.

The antennas 241 and 242 maybe sized and shaped to fit within the space specified by the relevant standard. In some implementations, the antennas 241 and 242 are sized and shaped to satisfy certain characteristics related to antenna performance in order to communicate with geostationary satellites and provide a satisfactory communication experience for passengers onboard the aircraft 240. In some implementations, a ground server antenna 230 can be provided to provide the connected network among the ground server 220, the aircraft 240, and the satellites 208, 209, 210, and 211. The ground server antenna 230 is only an example and other implementations are also possible. In some implementations, a wireless router such as an Internet modem can be configured to support the communication between the ground server 220 and the aircraft 240. In some implementations, a teleport can be configured to support the communication between the ground server 220 and the satellites 208, 209, 210, and 211.

In the implementations of the disclosed technology, the ground server 220, which is in communication with the aircraft 240, the satellites 208, 209, 210, and 211, and the terrestrial communication station 260, is configured to provide basic and updated regulatory, business, and technical rules which may be implemented by in-vehicle systems and devices onboard the aircraft 240. The ground server 220 can be configured to use a wide variety of resources including compute resources, storage resources, and other resources to configure the in-vehicle systems and devices onboard the aircraft 240 in accordance with the regulatory, business, and technical rules. The ground server 220 establishes the communication connections with the satellites 208, 209, 210, and 211 via a teleport (not shown). The ground server 220 can receive real time data from the satellites 208, 209, 210, and 211 and the terrestrial communication station 260. In addition, the multiple airplanes, Airplane 1 (AP1), Airplane 2 (AP2), Airplane 3 (AP3) … Airplane W (APW), are illustrated. Although some description above is provided for a single airplane in this document, those skilled in the art can understand that such description can be applied to the multiple airplanes. Thus, the ground server 220 can provide basic and updated regulatory, business, and technical rules for the multiple airplanes.

The ground server 220 can be configured in hardware, software, or any combination thereof. In some implementations, the ground server 220 can be configured in a cloud. In this case, the cloud platform for controlling aircraft services exists with servers, processes, and databases, which are able to be connected over a wide area network, such as the Internet, from multiple computing devices. The backend of the cloud platform is configured to provide the basic and updated regulatory, business, and technical rules, by dynamically calling in additional computing hardware machines to load on and run the independent processes as needed.

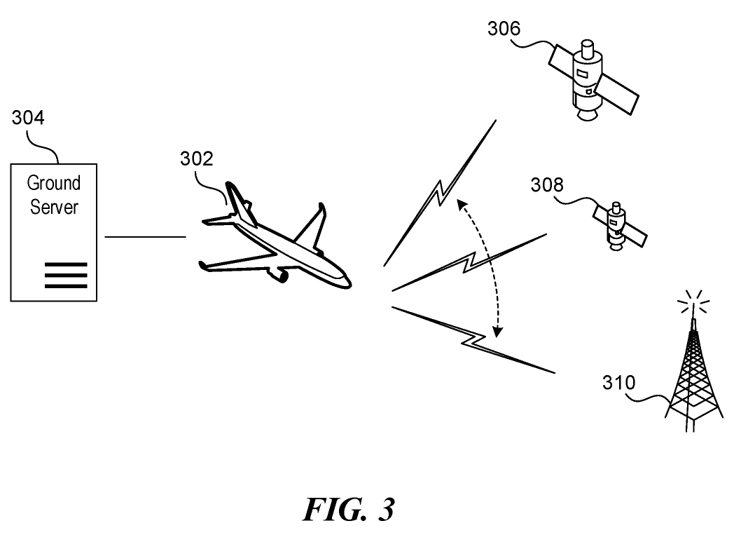

FIG. 3 shows an example of a communications system implemented as a ground server 304 operable to provide regulatory, business, and technical rules for a commercial transportation vehicle such as the airplane 302.

In the example of FIG. 3, the communications system may include a ground server 304 operable to provide various rules for operating systems and providing services onboard the commercial transportation vehicle. In the example, the communications system is in communication with the airplane 302 which is flying in the air. The airplane 302 is in communication with at least one of a GEO satellite 306, a LEO satellite 308, and the cellular network 310. In some implementations, the communications system includes a centralized decision-making element which can gather the various regulatory, business, and technical rules over at least one of the networks provided by the GEO satellite 306, the LEO satellite 308, and the cellular network 310 and configure services onboard the airplane 302 in accordance with the various rules. Some example rules may be related to airspace regulations, airline regulations, and customer preferences. In some implementations, the airplane 302 is on ground and the communications system uses the decision-making element to gather the various regulatory, business, and technical rules over at least one of the networks provided by the GEO satellite 306, the LEO satellite 308, the cellular network 310, and a ground Wi-Fi network (unpictured).

In implementations of the disclosed technology, the communications system configures airplane systems and services in accordance with rules provided by the decision-making element based on a triggering mechanism. For example, the triggering mechanism may be a passive mechanism related to changes in location of the airplane or a reactive mechanism initiated by a triggering event experienced by the airplane. Thus, in some implementations, the various rules to configure airplane systems and services are provided to the airplane in response to the triggering mechanism. Various triggering events can be preset (e.g., initiated when the airplane is within a specific distance from a territory) and upon detecting any one of the triggering events, the communications system starts the operations to configure systems and services onboard the airplane in accordance with the rules provided by the decision-making element. In some implementations, one or more servers included in the communications system may operate, in response to the triggering mechanism, to configure systems and services onboard the airplane. Further details regarding passive and reactive triggering mechanisms will be provided in the description that follows.

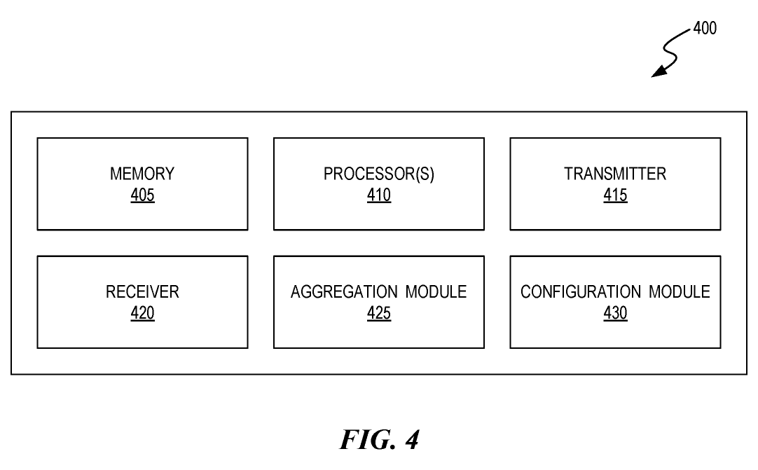

FIG. 4 shows an example of a block diagram of a system to provide various regulatory, technical, and business rules to a commercial transportation vehicle based on some implementations of the disclosed technology. The block diagram as shown in FIG. 4 can be applied to the ground server 304 as shown in FIG. 3. Referring to FIG. 4, the system 400 includes a memory 405, processor(s) 410, a transmitter 415, a receiver 420, an aggregation module 425, and a configuration module 430. In other embodiments, additional, fewer, and/or different elements may be used to configure the system 400. While FIG. 4 shows the processor 410, the aggregation module 425, and the configuration module 430 as separate elements, in some implementations, the processor 410, the aggregation module 425, and the configuration module 430 can be implemented as one element. In this case, the aggregation module 425 and the configuration module 430 can be configured as a part of the processor 410.

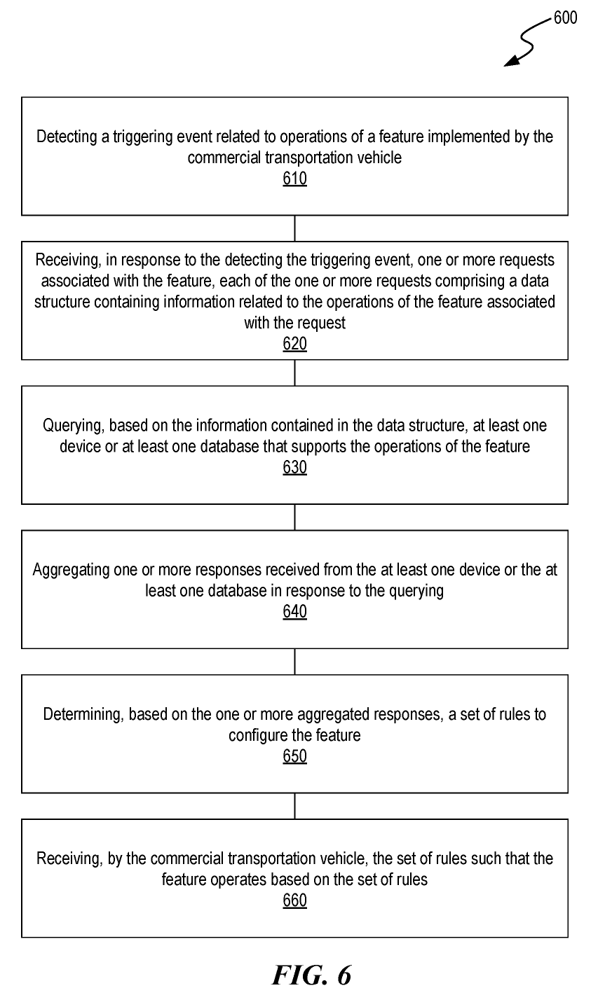

The memory 405 is an electronic holding place or storage for information or instructions so that the information or instructions can be accessed by the other elements of the system 400, which include processor(s) 410, the transmitter 415, the receiver 420, the aggregation module 425, the configuration module 430, etc. The memory 405 can include, but is not limited to, any type of random access memory (RAM), any type of read only memory (ROM), any type of flash memory, etc. Such as magnetic storage devices (e.g., hard disk, floppy disk, magnetic strips, etc.), optical disks (e.g., compact disk (CD), digital versatile discs (DVD), etc.), smart cards, flash memory devices, etc. The instructions upon execution by the processor 410 configure the system 400 to perform the operations (e.g., the operations, for example, as shown in FIG. 6) which will be described in this patent document. The instructions executed by the processor 410 may be carried out by a special purpose computer, logic circuits, or hardware circuits.

The processor 410 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 410 can perform the operations called for by that instruction. The processor 410 operably couples with the memory 405, the transmitter 415, the receiver 420, the aggregation module 425, and the configuration module 430 to receive, to send, and to process information and to control the operations of the ground server (e.g., 122 or 220) and/or the onboard server 244. The processor 410 may retrieve a set of instructions from a permanent memory device such as a ROM device and copy the instructions in an executable form to a temporary memory device that is generally some form of RAM. In some implementations, the ground server (e.g., 122 or 220) and/or the onboard server 244 can include a plurality of processors that use the same or a different processing technology. The transmitter 415 transmits or sends information or data to another device (e.g., another server 104 or PEDs 114). The receiver 420 receives information or data transmitted or sent e.g., by another server 104 or PEDs 114.

The system 400 includes the receiver 420 to receive information related to the airplane and the transmitter 415 to communicate with the airplane and provide the information. The transmitter 415 and the receiver 420 further allows the system 400 to communicate with a hybrid network system which may include multiple satellite networks and/or a cellular network. While the transmitter 415 and the receiver 420 are implemented as two separate elements, the transmitter 415 and the receiver 420 can be implemented as a single element, e.g., a communication module. In some implementations, the communication module may be in communication with various servers/platforms that operate as sources of various data that is related to a travel by a commercial transportation vehicle and provide any related information such as jurisdictional regulations, aircraft information, satellite network specifications, etc. to the commercial transportation vehicle. Such data can be inputted as the input data of the aggregation module 425 and the configuration module 430 and utilized to initiate the operations to configure systems and services onboard the commercial transportation vehicle in accordance with various regulatory, technical, and business rules.

In some implementations, the transmitter 415 is configured to send to the receiver 420 one or more requests comprising information to configure a service provided onboard the commercial transportation vehicle. The request may be associated with a particular service, hardware, or software platform implemented by the commercial transportation vehicle. In some implementations, the request is generated in response to a triggering mechanism.

In some examples, a request is generated by a captive user interface (UI) service provided to an airplane via a WISP. The request may include a set of business rules related to the Internet service, such as rules related to the timing of access to the service or changes to the workings of the services. In some implementations, the request includes a data structure. The data structure may include a list comprising, among other things, airline service-level agreements (SLAs), passenger SLAs, Internet frequency agreements, passenger subscription location, whether the passenger is subscribing via a mobile network operator (MNO), frequent flyer program, geographical locations associated with operating the captive UI service, and other forms of agreements and information.

In some examples, a request is generated by access point radios located in the cabin of the airplane (e.g., at flight start or at crew command). In some implementations, the request includes a data structure. The data structure may include, among other things, a list of enabled radios (e.g., 2.4 GHz, 5 GHz, 6 GHz, etc.), a list of allowed listed channels based on locations associated with each of the radios, and a list of supported aircraft services.

In some examples, a request is generated by a terminal associated with network communications for the airplane (e.g., an antenna terminal). In some implementations, the request is generated at doors close of the aircraft, at flight deck command, or upon powering on or changing a status of the terminal (e.g., disabled status to enabled status). In some implementations, the request includes a data structure. The data structure may include, among other things, a list of discrete states of the terminal (e.g., weight on wheels (WoW), engines on, doors closed, location, etc.), antenna specifications (e.g., frequencies), satellite network specifications (e.g., low Earth orbit satellite, medium Earth orbit satellite, geostationary Earth orbit satellite, OneWeb, Starlink, etc.).

In some examples, a request is generated via a Wi-Fi service (e.g., Wi-Fi Hotspot 2.0 service, Wi-Fi Certified Passpoint service, etc.) provided by the airplane. The request may include a set of business rules related to the Wi-Fi service, such as rules related to the timing of access to the service or changes to the workings of the service. In some implementations, the request includes a data structure. The data structure may include, among other things, airline SLAs, passenger SLAs, MNO provider SLAs, type of roaming procedure (e.g., home-routed versus local breakout), and MNO rules.

The aggregation module 425 is configured to receive and aggregate the data structures contained in each request generated by the captive UI service, the access point radios, the terminal associated with network communications for the airplane, and the Wi-Fi service at a centralized location. The data structures received by the aggregation module 425 may be aggregated, for example, using a Restful API. In some implementations, the aggregation module 425 is further configured to process the data structures received by the aggregation module 425. The aggregation module 425 may include various features to support processing of the data structures. For example, the aggregation module 425 may include a data aggregator configured to receive one or more of the data structures described above and prepare various requests to configure a service provided onboard the commercial transportation vehicle based on predetermined rules, as will be described in further detail. In some implementations, the data aggregator processes the data structures in an order.

In some implementations, the data aggregator is configured to obtain geographical location data of the airplane (e.g., latitude, longitude, yaw (heading), altitude, etc.) by querying, for example, a data bus or other intermediary software or hardware communicatively coupled to the airplane. In some implementations, the data aggregator is further configured to communicate with a map server. Upon obtaining the geographical location data, the data aggregator may send a query to the map server instructing the map server to retrieve rules for the airplane pertaining to the geographical location data (e.g., when flying over China, disable connectivity for unapproved satellites). The geographical location data may be stored, for example, in a database accessible to the aggregation module 425. In some implementations, the geographical location data corresponds to a geographical location the airplane is approaching or flying over. The rules retrieved by the map server may be communicated to the aggregation module 425.

The aggregation module 425 may retrieve and store various forms of information using one or more databases. In some implementations, the aggregation module 425 is configured to query a jurisdictional database containing additional information about laws and regulations based on the geographical location data (e.g., when flying over Japan, channels “x,” “y,” and “z” cannot be used). In some implementations, the aggregation module 425 queries the jurisdictional database in response to the map server retrieving the rules for the airplane.

In some implementations, the aggregation module 425 is configured to query another database which stores rules pertaining to the use of radio frequencies across all radio frequency (RF) equipment onboard the airplane (e.g., WAPs, Bluetooth, satellite antenna, cellular antenna, etc.). The rules pertaining to the use of radio frequencies may be based on the geographical location data (e.g., disable cellular connectivity while the airplane is located in Guam). In some implementations, the aggregation module 425 queries the database storing the radio frequency related rules after the aggregation module 425 has received a response from the jurisdictional database to the querying of the jurisdictional database.

In some implementations, the aggregation module 425 is configured to query a least-cost routing algorithm to determine a network the airplane should connect to. The least-cost routing algorithm may be employed by the aggregation module 425 to perform various types of data analysis to determine the network for the airplane to connect to. For example, the least-cost algorithm may be queried by the aggregation module 425 to determine an optimum network for the airplane based on a list of predetermined optimization preferences. In some implementations, the least-cost routing algorithm may determine a network for the airplane to connect to, based on a criticality (e.g., time-based criticality) of a payload. For example, the least-cost routing algorithm may consider a payload comprising BITE data and determine, based on a criticality of the BITE data, which network to connect to, based on whether the BITE data can afford to be delivered in a certain amount of time (e.g., 20 minutes). In some implementations, the least-cost routing algorithm may determine to select between GEO, MEO, LEO, and cellular connectivity based on a cost associated with each network for a particular geographical region or SLA information (e.g., SLA information contained in one or more data structures). The least-cost routing algorithm, in some implementations, may also be implemented using one or more weights. For example, when determining to select between GEO, MEO, LEO, and cellular connectivity, the least-cost routing algorithm may be implemented using one or more weights associated, for example, with a dollar cost, latency, or data throughput (e.g., speed) of the GEO, MEO, LEO, and cellular networks. By utilizing weights, the least-cost routing algorithm may determine, for instance, to select a more expensive network of the GEO, MEO, LEO, and cellular networks if the selected network presents higher speed or lower latency over the other networks.

The aggregation module 425 is configured to aggregate responses received by the aggregation module 425 as a result of querying the map server, one or more databases (e.g., the jurisdictional database), and the least-cost routing algorithm. In some implementations, the aggregation module 425 aggregates the responses in an order (e.g., an order in which the responses are received by the aggregation module 425). The aggregation module 425 is configured to perform a set of operations based on the aggregated responses from the map server, the one or more databases, and the-least cost routing algorithm. The set of operations may include operations, such as set intersection, which support or facilitate the breakdown of data structures received by the aggregation module 425 with the data aggregator.

The data aggregator is in communications with each of the captive UI service, the access point radios, the terminal associated with network communications for the airplane, and the Wi-Fi service. In some implementation, the data aggregator is configured to transmit, to each of the captive UI service, the access point radios, the terminal associated with network communications for the airplane, and the Wi-Fi service, information used to configure the particular service such as a set of rules. The information may be based on the aggregated responses received by the aggregation module 425 as a result of querying the map server, one or more databases (e.g., the jurisdictional database), and the least-cost routing algorithm. For example, in some implementations the data aggregator is configured to send to the captive UI service a data structure comprising satellite communication and/or cellular enablement rules for the airplane based on a current location of the airplane and a passenger country of origin (if required). In some implementations, the data aggregator is configured to send to the access point radios a data structure comprising a list of allowed channels per radio and a maximum power per channel at a current location of the airplane. In some implementations, the data aggregator is configured to send to the terminal associated with network communications for the airplane a data structure comprising agreements related to the use of radio frequencies and certain RF parameters (e.g., modulation, encoding, power levels, sidelobe requirements, etc.). In some implementations, the data aggregator is configured to send to the Wi-Fi service a data structure comprising satellite communication and/or cellular enablement rules for the airplane (e.g., whether voice over LTE is allowed) based on a current location of the airplane and country of origin regulations (e.g., lawful interruption regulations) associated with passenger(s) onboard the airplane.

The respective information received by the captive UI service, the access point radios, the terminal associated with network communications for the airplane, and the Wi-Fi service from the data aggregator can be utilized by the configuration module 430 to configure, respectively, the services provided by the captive UI service, the access point radios, the terminal associated with network communications for the airplane, and the Wi-Fi service. Thus, the system 400 is able to provide the best possible end-user experience by configuring, at a centralized location, services onboard the airplane to operate in accordance with various rules and regulations (e.g., SLA agreements, allowed radio frequencies, country of origin regulations, etc.).

In some implementations, one or more of the memory 405, the processor(s) 410, the transmitter 415, the receiver 420, the aggregation module 425, and the configuration module 430 may operate in response to a triggering mechanism. The triggering mechanism may be passively or actively driven. For example, in response to a change in location of the airplane (i.e., a passive triggering mechanism), the system 400 may be initiated to operate. In some implementations, an active triggering mechanism such as detection of a triggering event may cause the system 400 to operate. A triggering event may include, for example, airplane navigational systems detecting that the airplane is a distance away from crossing a country’s border. In response to the detecting of the triggering event, the system 400 may be initiated into operation prior to the airplane crossing the country’s border. Thus, the system 400 can be triggered to operate based on a distance from the airplane to a predetermined location. In some implementations, a triggering event is associated with the map server, one or more databases (e.g., the jurisdictional database), or the least-cost routing algorithm. In some implementations, the data aggregator is configured to generate and to send a data structure to the captive UI service, the access point radios, the terminal associated with network communications for the airplane, or the Wi-Fi service, respectively, in response to detection of the triggering event associated with the map server, the one or more databases, or the least-cost routing algorithm, respectively. For example, in response to detecting a current location of the airplane by the map server, the data aggregator may generate a data structure associated with the captive UI service (e.g., a data structure comprising satellite communication and/or cellular enablement rules for the airplane) and transmit the data structure to the aggregation module 425.

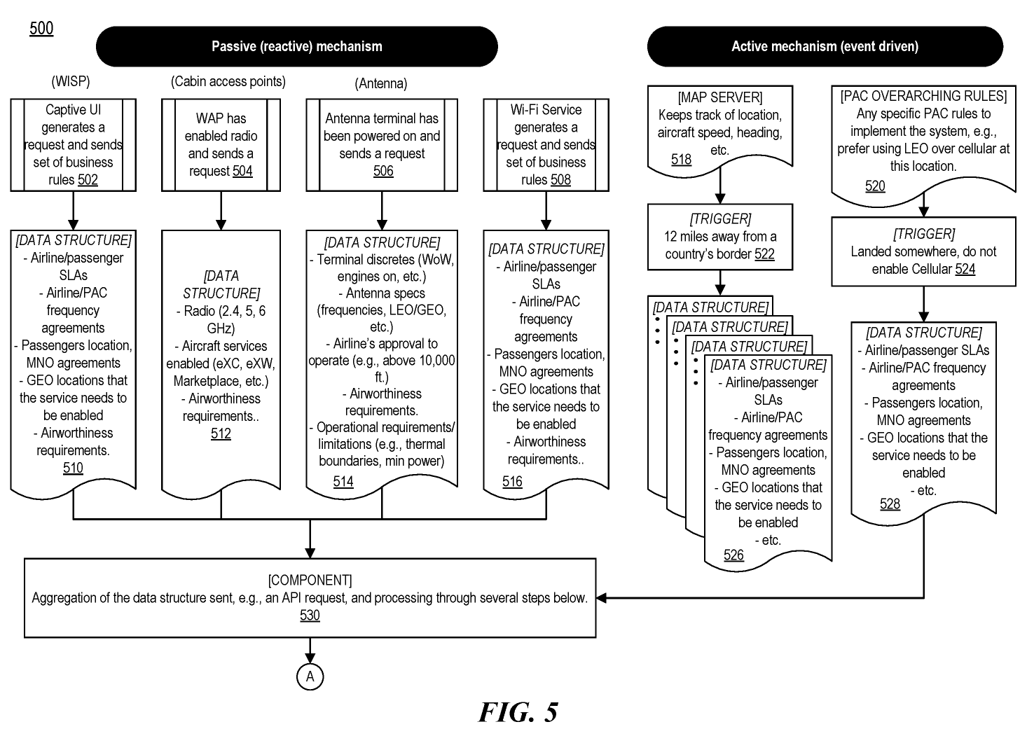

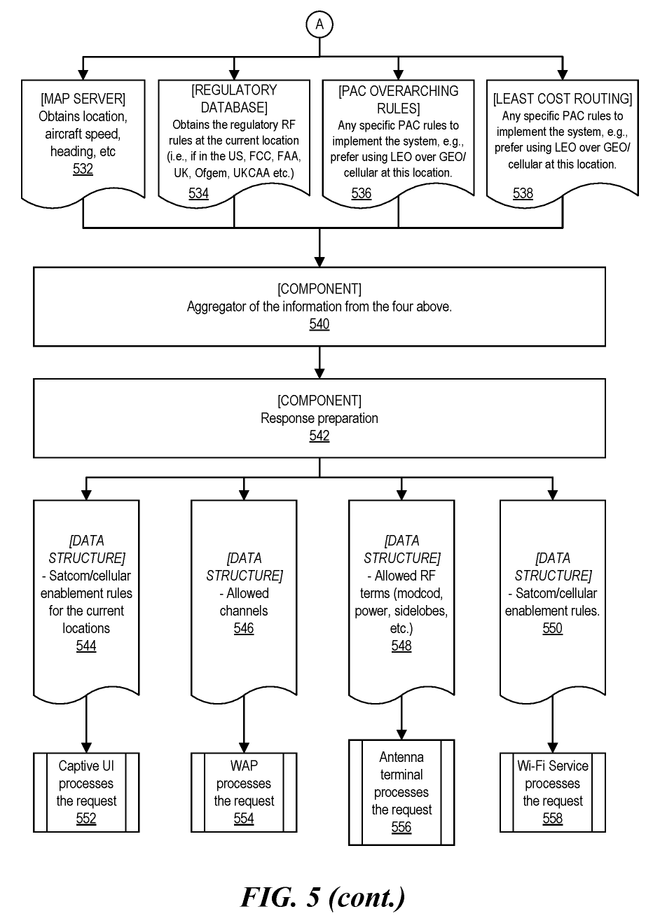

FIG. 5 shows a flow diagram of an example workflow 500 of communications systems for a commercial transportation vehicle based on some implementations of the disclosed technology. For example, the system 400 as shown in FIG. 4, including the memory 405, the processor(s) 410, the transmitter 415, the receiver 420, the aggregation module 425, and the configuration module 430, may be implemented to perform operations as shown in the workflow 500. In some implementations of the workflow 500, the commercial transportation vehicle is an airplane which implements operations shown in FIG. 5 in response to a passive or active triggering mechanism. For example, a passive triggering mechanism may be activated based on changes in location of the airplane and an active triggering mechanism may be activated in response to the airplane detecting a triggering event which may be predetermined (e.g., detecting that the airplane is within a predetermined distance from a territory). Upon the airplane detecting the triggering event, communications systems for the airplane start operations to configure systems and services onboard the airplane according to the workflow 500. In some implementations, one or more servers or databases included in the communications system may operate, upon activation of the triggering mechanism, to configure the systems and services onboard the airplane.

In one example implementation of the workflow 500, the airplane is passively triggered by a passive triggering mechanism to implement the following operations illustrated in FIG. 5. At operations 502, 504, 506, and 508, multiple features of the airplane, in response to activation of the passive triggering mechanism, each send a request comprising a data structure to a data aggregation component (e.g., a software or hardware) configured to receive the request from each of the features at a centralized location. Such features may include, for example, a hardware, a software, a service, or other platform or piece of equipment that supports operations of the airplane. In the example of FIG. 5, the multiple features include a captive UI service provided by a WISP, cabin access point radios, an antenna terminal, and a Wi-Fi service. At operation 502, a request is generated by the captive UI service and comprises a data structure 510 containing one or more of the following: a service-level agreement (SLA) associated with the airline, an SLA associated with a passenger, a frequency agreement associated with the airline, passenger location data, a mobile network operator (MNO) agreement, geographic location data associated with operating the captive UI service, or an airworthiness requirement, among others. At operation 504, a request is generated by at least one of an enabled cabin access point radio and the request comprises a data structure 512 containing one or more of the following: a radio frequency, a list of enabled aircraft services, or an airworthiness requirement, among others. At operation 506, a request associated with the antenna terminal is generated and the request comprises a data structure 514 containing one or more of an aircraft-generated information or command such as a discrete state of the airplane or airplane subsystems (e.g., weight on wheels (WoW), engines on, etc.), an antenna specification (e.g., frequencies, GEO/MEO/LEO), a satellite network specification (e.g., GEO/MEO/LEO), an airline approval to operate (e.eg., above 10,000 ft), an airworthiness requirement, or an operational requirement or limitation related to operations of the antenna terminal (e.g., thermal boundaries, minimum power), among others. At operation 508, a request associated with the Wi-Fi service is generated and comprises a data structure 516 containing one or more of the following: an SLA associated with the airline, an SLA associated with a passenger, a frequency agreement associated with the airline, passenger location data, a mobile network operator (MNO) agreement, geographic location data associated with operating the Wi-Fi service, or an airworthiness requirement, among others.

At operation 530, the data aggregation component aggregates each of the data structures 510, 512, 514, and 516. In some implementations, the data aggregation component aggregates the data structures 510, 512, 514, and 516 using an API protocol (e.g., Restful API). The data aggregation component is configured to process the data structures 510, 512, 514, and 516 from each of the multiple features and prepare various requests to relevant sub-features which can provide or compute various rules for the airplane. At operation 532, the data aggregation component obtains aircraft geographical location data (e.g., latitude, longitude, yaw (heading), altitude) by querying a data bus or intermediary software/hardware. During operation 532, the data aggregation component queries a map server which tracks location and speed information of the airplane and which provides to the data aggregation component exclusions, for at least some of the multiple features, pertaining to the current airplane location (e.g., when flying over China, disable LEO connectivity). In some implementations, the map server is queried by the data aggregation component after the data aggregation component has obtained the aircraft geographical location data. After receiving a response from the map server during operation 532, the data aggregation component, at operation 534, queries a jurisdictional database which contains information about laws and regulations for airplane features based on the location of the airplane (e.g., when flying over Japan, channels “x”, “y”, and “z” cannot be used). In some implementations, the information contained in the jurisdictional database includes regulatory radio frequency (RF) rules based on the current location of the airplane. After receiving a response from the jurisdictional database during operation 534, the data aggregation component, at operation 536, queries an overarching rules database which contains airline-specific rules including rules pertaining to the use of radio frequencies across all RF equipment onboard the airplane (e.g., wireless access points, Bluetooth, Satcom antenna, cellular antenna, etc.). At operation 538, the data aggregation component queries a least-cost routing algorithm to determine a network for the airplane to connect to, based on predefined preferences and/or a payload criticality (e.g., time criticality). For example, the least-cost routing algorithm may be consulted by the data aggregation component to determine whether the airplane should utilize GEO, MEO, LEO, or cellular connectivity based on the respective costs of GEO, MEO, LEO, and cellular networks in a given geographic region. In some implementations, the least-cost routing algorithm utilizes weights associated, e.g., with dollar cost, latency or data throughput, in such a way that a more expensive network may be selected if, for example, the selected network presents higher speed or lower latency over an alternate network(s). In some implementations, the least-cost routing algorithm, regardless of the network parameters, may consider a payload (e.g., BITE data or payment data from a passenger device) and determine the network for the airplane to connect to, based on a time-criticality of the payload (e.g., whether the BITE data can afford to be delivered in 20 minutes). In some implementations, each of the responses from the map server, the jurisdictional database, the overarching rules database, and the least-cost routing algorithm during operations 532, 534, 536, and 538 are received by the data aggregation component in the form of a data structure.

At operation 540, the data aggregation component aggregates the responses and information obtained from operations 532, 534, 536, and 538 in an order such as an ascending order in which the responses are received. During operation 540, the data aggregation component may perform a set of operations, including set intersection, to break down the data structure in each response received during operations 532, 534, 536, and 538 and determine which data structure is useable to which of the multiple features of the airplane (i.e., the captive UI service, the cabin access point radios, the antenna terminal, and the Wi-Fi service). At operation 542, the data aggregation component prepares a request, comprising a data structure, which is to be sent to each of the multiple features based on results of operation 540. At operation 544, the data aggregation component sends to the captive UI service a data structure comprising, for example, satellite communication and cellular enablement rules based on the current aircraft location and a passenger country of origin (if required). At operation 546, the data aggregation component sends to the cabin access point radios a data structure comprising, for example, a list of allowed channels per radio or a maximum power per channel in a current location of the airplane. At operation 548, the data aggregation component sends to the antenna terminal a data structure comprising, for example, allowed RF agreements or allowed RF parameters (e.g., modulation, encoding, power levels, sidelobe requirements, etc.). At operation 550, the data aggregation component sends to the Wi-Fi service a data structure comprising, for example, satellite communication and cellular enablement rules based on the current aircraft location (e.g., whether voice over LTE is allowed) and passenger country of origin regulations (e.g., lawful interruption is required). In some implementations, data structures in operations 544, 546, 548, and 550 are included as part of a request sent by the data aggregation component to the captive UI service, the cabin access point radios, the antenna terminal, or the Wi-Fi service.

The data structures sent to the captive UI service, the cabin access point radios, the antenna terminal, and the Wi-Fi service during operations 544, 546, 548, and 550 are received and processed by the captive UI service, the cabin access point radios, the antenna terminal, and the Wi-Fi service, respectively, during operations 552, 554, 556, and 558. At operation 552, the captive UI service processes the request containing the data structure sent to the captive UI service during operation 544. At operation 554, the cabin access point radios process the request containing the data structure sent to the cabin access point radios during operation 546. At operation 556, the antenna terminal processes the request containing the data structure sent to the antenna terminal during operation 548. At operation 558, the Wi-Fi service processes the request containing the data structure sent to the Wi-Fi service during operation 550. In some implementations, the information included in each of the data structures of operations 544, 546, 548, and 550 comprises a set of rules to configure the captive UI service, the cabin access point radios, the antenna terminal, or the Wi-Fi service. In some implementations, the captive UI service, the cabin access point radios, the antenna terminal, and the Wi-Fi service receives a respective set of rules at operations 552, 554, 556, or 558 and configures its operations based on the respective set of rules.

In another example implementation of the workflow 500, the airplane is actively triggered by an active triggering mechanism to implement operations illustrated in FIG. 5. In this example implementation, the multiple features of the airplane (i.e., the captive UI service, the cabin access point radios, the antenna terminal, and the Wi-Fi service) respectively issue a trigger when a specific triggering event is detected by the respective feature. In some implementations, the triggering event is predetermined (e.g., determined based on territorial regulations for the feature which need to be implemented when the airplane is within a predetermined distance of crossing the border of a country). In some implementations, the map server at operation 518 may be tracking aircraft information (e.g., location data, speed, heading, etc.) and detect, at operation 522, a triggering event related to the aircraft approaching the border of a country. Upon detection of the triggering event at operation 522, the data structures shown to be generated in FIG. 5 at operations 510, 512, 514, and 516 are instead generated at operation 526 and aggregated by the data aggregation component at operation 530. In another example scenario, the overarching rules database contains airline-specific operating rules as shown in operation 520. At operation 524, a triggering event indicating that the airplane has landed is detected. In some implementations, the triggering event at operation 524 is a preset trigger to disable/enable cellular connectivity for the airplane. In response to the triggering event at operation 524, a data structure pertaining to operations of the captive UI interface or the Wi-Fi service is generated at operation 528 (rather than operation 510 or 516) and aggregated by the data aggregation component at operation 530. Operations 530, 532, 534, 536, 538, 540, 542, 544, 546, 548, 550, 552, 554, 556, and 558 are then carried out as previously described.

In some implementations of the workflow 500, each of the multiple features of the airplane (e.g., the captive UI interface, the cabin access point radios, the antenna terminal, and the Wi-Fi service) are in communication with a server, such as a ground server, configured to control hardware for the multiple features. In some implementations, the multiple features are updated via a data file which is pushed from the server to the hardware. The data file may include data structures shown in FIG. 5 such as any one of the data structures in operations 544, 546, 548, or 550.

FIG. 6 shows a flow diagram illustrating an example of a computer-implemented method 600 of operating a commercial transportation vehicle. Referring to FIG. 6, at the operation 610, the method 600 includes detecting a triggering event related to operations of a feature implemented by the commercial transportation vehicle. In some implementations, the feature comprises a service, a hardware or a software. At operation 620, the method 600 includes receiving, in response to the detecting the triggering event, one or more requests associated with the feature, each of the one or more requests comprising a data structure containing information related to the operations of the feature associated with the request. At operation 630, the method 600 includes querying, based on the information contained in the data structure, at least one device or at least one database that supports the operations of the feature. At operation 640, the method 600 includes aggregating one or more responses received from the at least one device or the at least one database in response to the querying. At operation 650, the method 600 includes determining, based on the one or more aggregated responses, a set of rules to configure the feature. At operation 660, the method 600 includes receiving, by the commercial transportation vehicle, the set of rules such that the feature operates based on the set of rules.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware, or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this patent document.

What is claimed is:

1. A computer-implemented method of operating a commercial transportation vehicle, comprising:
detecting a triggering event related to operations of a feature implemented by the commercial transportation vehicle, wherein the feature comprises a service, a hardware or a software;
receiving, in response to the detecting the triggering event, one or more requests associated with the feature, each of the one or more requests comprising a data structure containing information related to the operations of the feature associated with the request;
querying, based on the information contained in the data structure, at least one device or at least one database that supports the operations of the feature;
aggregating one or more responses received from the at least one device or the at least one database in response to the querying;
determining, based on the one or more aggregated responses, a set of rules to configure the feature; and
receiving, by the commercial transportation vehicle, the set of rules such that the feature operates based on the set of rules.

2. The computer-implemented method of claim 1, wherein multiple features are implemented by the commercial transportation vehicle, wherein the multiple features include at least one of:
a captive user interface (UI) service provided to the commercial transportation vehicle via a wireless internet service provider;
one or more access point radios located onboard the commercial transportation vehicle;
an antenna terminal that supports network communications services provided to the commercial transportation vehicle; and
a wireless internet service provided by the transportation vehicle.

3. The computer-implemented method of claim 2, wherein the data structure contains information related to the operations of the captive UI interface, the one or more access point radios, the antenna terminal, or the wireless internet service,
wherein information related to the operations of the captive UI interface comprises one or more of an airline service-level agreement (SLA), a passenger SLA, an Internet frequency agreement, a passenger subscription information, a frequent flyer information, or a geographic location information associated with operating the captive UI service,
wherein information related to the operations of the one or more access point radios comprises one or more of a list of enabled access point radios, a list of allowed channels based on a location associated with each of the enabled access point radios, a maximum power per allowed channel based on a current location of the transportation vehicle, or a list of supported in-vehicle services,
wherein the information related to the operations of the antenna terminal comprises one or more of a discrete state of the antenna terminal, an antenna specification, or a satellite network specification, and
wherein the information related to operations of the wireless internet service comprises one or more of an SLA associated with the airline, an SLA associated with a passenger, an SLA associated with a mobile network operator (MNO) provider, a type of roaming procedure, MNO rules associated with the wireless internet service, or cellular enablement rules based on the current location of the commercial transportation vehicle.

4. The computer-implemented method of claim 1, wherein the one or more responses are aggregated based on an order in which the querying is performed.

5. The computer-implemented method of claim 1, wherein the detecting the triggering event is based on a change of location of the transportation vehicle, and wherein, in response to the detecting the triggering event, the feature is initiated to perform the operations based on the set of rules.

6. The computer-implemented method of claim 1, wherein at least some of the set of rules are received by the transportation vehicle from a server in communication with the at least one device or the at least one database, wherein the server is configured to send to the transportation vehicle the at least some of the set of rules in a data file that is communicated to hardware controlling the feature.

7. The computer-implemented method of claim 1, wherein the querying comprises:
receiving, by a map server, instructions to retrieve at least some of the set of rules based on geographical location data of the transportation vehicle.

8. The computer-implemented method of claim 7, wherein the at least one database includes a jurisdictional database storing information pertaining to laws and regulations which are based on the geographical location data, wherein the querying further comprises:
querying the jurisdictional database in response to the map server retrieving the rules for the transportation vehicle.

9. The computer-implemented method of claim 8, wherein the set of rules includes at least one rule related to usage of radio frequencies by radio frequency (RF) equipment onboard the transportation vehicle, wherein the at least one rule is based on the geographical location data and stored in a radio frequency database accessible to the transportation vehicle.

10. The computer-implemented of claim 9, wherein the one or more responses include a response from the jurisdictional database, wherein, upon receiving the response from the jurisdictional database, the radio frequency database is queried.

11. The computer-implemented method of claim 1, further comprising:
determining, by a least-cost routing algorithm, a network for the transportation vehicle to connect to,
wherein the determining is based on one or more predetermined preferences relating to a criticality of a network payload or a cost associated with network usage in a particular geographical region.

12. The computer-implemented method of claim 11, wherein the least-cost routing algorithm is configured to perform the determining using one or more weights, wherein the one or more weights are associated with a cost, a latency, or a data throughput of the network.

13. A system of operating a commercial transportation vehicle, comprising:
at least one storage configured to store data supporting a feature implemented by the commercial transportation vehicle, wherein the feature comprises a service, a hardware or a software;
a server in communication with the at least one storage and the commercial transportation vehicle; and
a computer-implemented device,
wherein the computer-implemented device is configured to perform operations comprising:
receive at least one data structure associated with the feature;
query, based on information contained in the data structure, at least one of the server or the at least one storage;
aggregate one or more responses received from the at least one of the server or the at least one storage in response to the querying;
determine, based on the aggregated one or more responses, a set of rules to configure the feature; and
communicate the set of rules to the feature such that the feature operates based on the set of rules.

14. The system of claim 13, wherein multiple features are implemented by the transportation vehicle, wherein the multiple features include at least one of:
a captive user interface (UI) service provided to the transportation vehicle via a wireless internet service provider;
one or more access point radios located onboard the transportation vehicle;
an antenna terminal that supports network communications services provided to the transportation vehicle; and
a wireless internet service provided by the transportation vehicle,
wherein the data aggregator is configured to receive a first data structure associated with the captive UI service, a second data structure associated with the one or more access point radios, a third data structure associated with the antenna terminal, and a fourth data structure associated with the wireless internet service.

15. The system of claim 14, wherein:
the first data structure includes one or more of an airline service-level agreement (SLA), a passenger SLA, an Internet frequency agreement, a passenger subscription information, a frequent flyer information, or a geographic location information associated with operating the captive UI service,
the second data structure includes one or more of a list of enabled access point radios, a list of allowed channels based on a location associated with each of the enabled access point radios, a maximum power per allowed channel based on a current location of the transportation vehicle, or a list of supported in-vehicle services,
the third data structure comprises one or more of a discrete state of the antenna terminal, an antenna specification, or a satellite network specification, and
the fourth data structure comprises one or more of an SLA associated with the airline, an SLA associated with a passenger, an SLA associated with a mobile network operator (MNO) provider, a type of roaming procedure, MNO rules associated with the wireless internet service, or cellular enablement rules based on the current location of the transportation vehicle.

16. The system of claim 13, wherein the computer-implemented device is configured to perform the operations in response to the transportation vehicle detecting a triggering event, wherein the detecting the triggering event is based on a change of location of the transportation vehicle.

17. The system of claim 13, wherein the query comprises:
instructing at least one of the server or the at least one storage to retrieve at least some of the set of rules based on geographical location data of the transportation vehicle.

18. The system of claim 17, wherein the set of rules includes at least one rule related to usage of radio frequencies by radio frequency (RF) equipment onboard the transportation vehicle, wherein the at least one rule is based on the geographical location data and stored in a radio frequency database accessible to the transportation vehicle.

19. The system of claim 18, wherein the query comprises querying the radio frequency database and a least-cost routing algorithm, wherein the computer-implemented device is configured to aggregate the one or more responses according to an order in which the server, the at least one storage, the radio frequency database, and the least-cost routing algorithm are queried, wherein the order comprises: querying the server, querying the at least one storage after the querying the server, querying the radio frequency database after the querying the storage, and querying the least-cost routing algorithm after the querying the radio frequency database.

20. The system of claim 13, wherein the one or more data structures are included in a request generated by the feature and received by the computer-implemented device.
